(19) United States
(12) Patent Application Publication
(10) Pub. No.: US 2023/0339340 A1
(43) Pub. Date: Oct. 26, 2023

(54) LOCKING DEVICE

(71) Applicant: Phoenix Contact E-Mobility GmbH, Schieder-Schwalenberg (DE)

(72) Inventors: Carsten Garth, Lemgo (DE); Cedric Deppe, Doerentrup (DE)

(21) Appl. No.: 17/796,273

(22) PCT Filed: Jan. 21, 2021
(86) PCT No.: PCT/EP2021/051246

§ 371 Date: Oct. 14, 2022

(30) Foreign Application Priority Data
Jan. 30, 2020 (DE) 10 2020 102 209.3

(51) Int. Cl. B60L 53/16; H01R 13/639

(52) U.S. Cl. CPC B60L 53/16; H01R 13/639

(57) ABSTRACT

A locking device for a charging socket for charging an electric vehicle includes: an actuator for locking the charging socket with a corresponding charging plug in a plugged-on state; a fastener which is fixable or fixed to the charging socket; and a retainer for detachably arranging the actuator on the fastener. The retainer is arrangeable or arranged on the fastener and is detachable from the fastener via a relative movement between the retainer and the fastener

### CROSS-REFERENCE TO PRIOR APPLICATIONS

This application is a U.S. National Phase application under 35 U.S.C. § 371 of International Application No. PCT/EP2021/051246, filed on Jan. 21, 2021, and claims benefit to German Patent Application No. DE 10 2020 102 209.3, filed on Jan. 30, 2020. The International Application was published in German on Aug. 5, 2021 as WO/2021/151763 under PCT Article 21(2).

### FIELD

The invention relates to a locking device for a charging socket for charging an electric vehicle. Furthermore, the invention relates to a charging connection for an electric vehicle.

### BACKGROUND

Electric vehicles use electrical energy to drive. Typically, electric vehicles are charged at charging stations via a cable connection. Small electric vehicles, such as electric bicycles, usually charge only small amounts of energy. Not least due to the power limitation of the charging devices for electric bicycles, for example, household safety sockets are sufficient for electric bicycles as charging sockets. Charging stations with higher powers, which serve to charge larger motor vehicles with an electric motor in a shorter period of time, usually have standardized charging sockets.

For example, in European Union Directive 2014/94/EU, it is required that each charging station with more than 3.7 kW alternating current charging power, AC, have a connection according to IEC 62196 Type 2. Furthermore, each charging station with more than 22 kW direct current charging power, DC, shall have a connection according to the combined charging system, CCS. In other geographical regions, connections designed otherwise can also be used. For example, the connections described in the IEC 62196-2:2011 standard as Type 1 are often used in North America.

In order to prevent unauthorized removal of a charging cable, as well as voltage peaks and associated arcing when the charging cable is removed during charging, a lock is often provided for the charging plug in the charging socket during the charging process. In the case of a Type 1 connection, a latch is located on the upper side of the charging plug, which latch engages during insertion. In the case of the Type 2 plugs, a locking pin, which can also be referred to as a pin, is moved at the charging socket from the side or from above into a recess provided for this purpose on the charging plug.

The locking pin is often moved electromechanically by means of a locking device. Such a locking device is described in, for example, DE 10 2018 114 205 A1 and can be arranged directly at the charging socket or in the surroundings of the charging socket.

In some cases, e.g., in the event of a defect in the actuator of the locking device, or in the event of an electrical problem, a rapid disconnection of the charging plug from the corresponding charging socket may be necessary. Therefore, some locking devices known from the prior art provide an emergency unlocking function that cancels the electromechanical locking. Often, via such emergency unlockings, the locking pin can be mechanically moved directly, or via a cable pull from the interior of the electric vehicle.

The locking devices known from the prior art have the disadvantage that the technical implementation by means of an emergency unlocking lever is complicated, since this often works against the self-locking of the motor and the transmission, and has to travel the entire path of the locking pin on the actuator with a relatively small movement. Moreover, it is not always desirable to have to use an actuating mechanism such as a cable pull.

### SUMMARY

In an embodiment, the present invention provides a locking device for a charging socket for charging an electric vehicle, comprising: an actuator configured to lock the charging socket with a corresponding charging plug in a plugged-on state; a fastener which is fixable or fixed to the charging socket; and a retainer configured to detachably arrange the actuator on the fastener, wherein the retainer is arrangeable or arranged on the fastener and is detachable from the fastener via a relative movement between the retainer and the fastener.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a front view of a charging socket with a locking device in an unlocked state according to a first embodiment;

FIG. 2 a front view of the charging socket with the locking device in a locked state according to the first embodiment;

FIG. 3 a side view of the charging socket with the locking device in a locked state according to the first embodiment;

FIGS. 4A-7 different views of the charging socket with the locking device according to the first embodiment during an emergency unlocking process; and

FIGS. 8-10 views of retaining means and fastening means according to a second, third, and fourth embodiment.

### DETAILED DESCRIPTION

In an embodiment, the present invention provides a locking device having an improved emergency unlocking of the locking device.

Accordingly, a locking device for a charging socket for charging an electric vehicle is provided, having:
an actuator designed to lock the charging socket with a corresponding charging plug in a plugged-on state;
a fastening means that can be fixed or is fixed to the charging socket; and
a retaining means adapted for detachably arranging the actuator on the fastening means, wherein the retaining means is arrangeable or arranged on the fastening means and is detachable from the fastening means via a relative movement between the retaining means and the fastening means.

The charging socket can be arranged, for example, directly on the electric vehicle and can be adapted to a charging cable via a corresponding charging plug, which is plugged into the charging socket. Alternatively, the charging socket can also be arranged at the charging station. The charging socket can, for example, be a charging socket according to Type 2 or Combo 2. In examples, the charging socket can also be a charging socket according to further known types, such as a charging socket according to the GB/T standard or the CCS Type 1 standard.

The actuator can comprise a locking means, e.g., a locking pin, and can be adapted to move the locking pin electromechanically along an axis as a function of an electrical signal. For example, the locking device can be arranged on the charging socket in such a way that the locking pin can be moved through an opening in a housing of the charging socket into a further opening or recess along the axis into the charging plug located in the charging socket.

The term, “fastening means,” can be understood to denote a means that serves to arrange the actuator at the charging socket. For example, the fastening means can comprise one or more fastening bolts that are arranged at least in regions in the housing of the charging socket, and/or protrude out of the housing, so that the actuator can be plugged onto the fastening bolt(s). The retaining means can be designed, for example, as a fastening clip or fastening plate, and can be adapted to be detachably arranged on an end region of the fastening bolt(s). In an assembled state, the actuator can thus be pushed onto the fastening means, such as, for example, onto the fastening bolt, and can be held at the charging socket by the retaining means, such as, for example, the fastening clip or the fastening plate.

The retaining means is, advantageously, adapted to detachably arrange the actuator on the fastening means, wherein the retaining means is arrangeable or arranged on the fastening means and is detachable from the fastening means via a relative movement between the retaining means and the fastening means.

The term, “relative movement,” can mean, for example, a horizontal and/or vertical displacement of the retaining means relative to the fastening means, in order to detach the retaining means from the fastening means so that the actuator is detachable from the fastening means. Furthermore, a rotational movement of the retaining means relative to the fastening means can also be understood as “relative movement.” Furthermore, pressing or pulling the retaining means relative to the fastening means can also be understood as “relative movement.”

In the locking device described herein, the fastening of the actuator to the charging socket can, advantageously, be detached in the event of an emergency unlocking, so that the locking means can deflect with the actuator in order to detach the charging plug without the locking means having to be moved via an emergency unlocking lever.

In one example, the fastening means comprises at least one fastening bolt, wherein the fastening bolt can be fixed or is fixed at a first end to the charging socket and has, at a second end that is opposite the first end, a first retaining geometry for detachably arranging the retaining means.

For example, the first end of the fastening bolt can be fixed or is fixed to the housing of the charging socket via a screw connection or an adhesive bond. In further examples, the first end of the fastening bolt can also be cast in the housing of the charging socket.

Advantageously, fixing the fastening bolt via a screw connection makes possible the subsequent equipping of charging sockets with the locking device described herein.

In one example, the first retaining geometry comprises a groove, arranged at least in regions on the circumference of the fastening bolt, or a collar.

The first retaining geometry can be designed such that the retaining means on the fastening bolt is detachable from the fastening means via a relative movement between the retaining means and the fastening means.

In one example, the actuator comprises a housing with at least one opening—in particular, a through-opening—adapted to receive the fastening bolt, at least in regions.

Advantageously, the actuator can be plugged onto the fastening bolt and thus can be securely fixed to the charging socket.

In one example, the retaining means is detachable from the fastening means via a rotary closure—in particular, a bayonet closure—or via a sliding closure.

Advantageously, by fixing the retaining means to the fastening means by means of a rotary closure or sliding closure, a mechanical connection, which can be quickly established and detached, between the retaining means and the fastening means can be created.

In one example, the retaining means comprises a fastening plate with at least one opening with a second retaining geometry for arranging the retaining means on the fastening means.

The second retaining geometry can be designed to correspond to the first retaining geometry and, with the first retaining geometry, can be adapted to the fastening bolt.

In one example, the second retaining geometry comprises a keyhole contour, an elongated hole opened on one side, and/or a connecting bar section.

In one example, the retaining means is designed in several parts—in particular, in two parts.

In this example, two or more parts of the retaining means can, advantageously, be separated from one another in order to detach the retaining means from the fastening means. As a result, an even more rapid detachability of the retaining means can be achieved.

In one example, the retaining means has a position securing means—in particular, a spring-loaded tab—for retaining the retaining means on the actuator and/or the charging socket.

The linkage of the actuator to the charging socket can, advantageously, be improved by the use of the position securing means.

In one example, an elastic element—in particular, a spring element and/or a seal—is arranged on the retaining means and/or between the actuator and the retaining means.

For example, the spring element can be formed from a free-stamped tongue in the material of the retaining means, which, in a locked state of the locking device, rests on the actuator and thus pretensions the retaining means, so that the retaining means automatically springs out of its position after being detached from the fastening means. Alternatively or additionally, a compressible seal can be arranged between the retaining means and the actuator in order to pretension the retaining means.

The invention also relates to a charging connection for an electric vehicle, having a charging socket; and a locking device as described herein, wherein the locking device is arranged at the charging socket.

In further examples, the charging connection can have the features described with respect to the locking device.

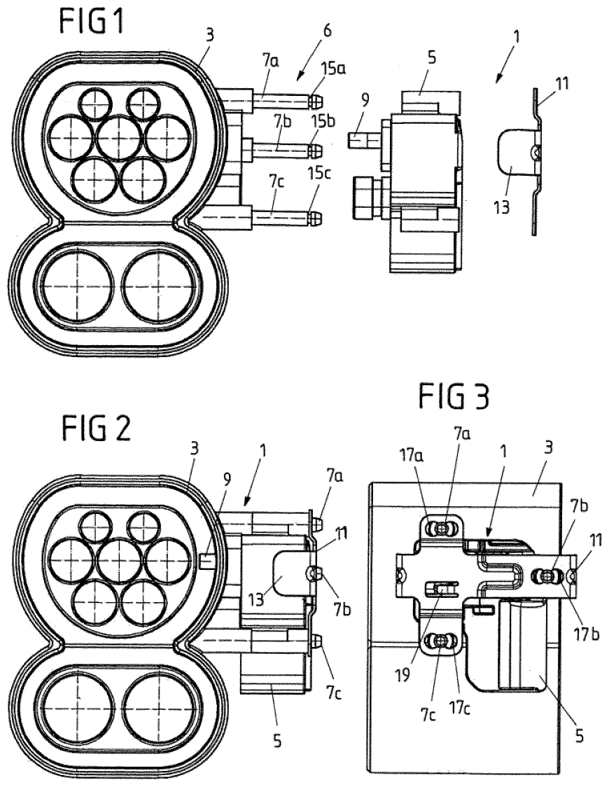

FIG. 1 shows a front view of a charging socket 3 with a locking device 1 in an unlocked state according to a first embodiment.

FIG. 1 shows, by way of example, the charging socket 3 as a combined charging system, Combo-2, charging socket, for alternating current charging and direct current charging. However, it is known to the person skilled in the art that the locking device 1 can also be arranged on other known charging sockets.

For detachably arranging the actuator 5, the fastening means 6, as shown in FIG. 1, comprises fastening bolts 7a-7c, which are fixed at a first end in a housing of the charging socket 3 and, with a second end, protrude from the housing. In the embodiment shown, the actuator 5 can be fitted onto the fastening bolts 7a-7c, so that a locking pin 9 of the actuator 5 can move through an opening in the housing of the charging socket 3 into a region of the charging socket 3, in order to lock a corresponding charging plug in the charging socket 3. An exemplary opening in the housing of the charging socket 3 is shown in FIG. 7, and FIG. 2 shows the arrangement of the extended locking pin 9 in the housing of the charging socket 3. The extended locking pin 9 is adapted to engage in a corresponding recess in a housing of the charging plug. In the embodiment shown, the locking pin 9 can, for example, be moved electromechanically in the horizontal direction and thus automatically lock the charging plug in the charging socket 3 during the charging process. Depending upon the arrangement of the locking device on the charging socket, the locking pin can, in embodiments not shown, also be moved vertically or horizontally into the housing of the charging socket.

FIG. 1 furthermore shows a retaining means 11 that is adapted to detachably arrange the actuator 5 on the fastening bolts 7a-7c. In the embodiment shown, the retaining means 11 comprises a fastening plate with in each case three openings with a second retaining geometry 17a-17c, as shown in FIG. 3. The second retaining geometry 17a-17c is adapted to engage in each case in a first retaining geometry 15a-15c, which is shown in FIG. 1 as a circumferential groove on a respective fastening bolt 7a-7c.

FIG. 2 shows a front view of the charging socket 3 with the locking device 1 in a locked state, according to the first embodiment already shown in FIG. 1. In FIG. 2, the actuator 9 is plugged onto the fastening bolts 7a-7c and is held by the retaining means 11 on the housing of the charging socket 3 via the fastening bolts 7a-7c. Furthermore, a position securing means 13 already shown in FIG. 1 is shown, which is depicted as an angled edge of the retaining means 11 and can also serve as an engagement surface for displacing the retaining means 11.

FIG. 3 shows a side view of the already previously shown charging socket 3 with the locking device 1 in the locked state. The second retaining geometry 17a-17c at the respective openings in the retaining means 11 is shown as an elongated hole with a tapered region between the two ends of the elongated hole. In the embodiment shown, the tapered region is arranged in the respective openings in a corresponding first retaining geometry 15a-15c, shown as a circumferential groove, on the fastening bolts 7a-7c, in order to arrange the retaining means 11 on the fastening bolts 7a-7c. Via a horizontal sliding movement of the retaining means 11 relative to the fastening means 6, the retaining means 11 is detachable from the fastening means 6. Furthermore, FIG. 3 shows a spring element 19 that is arranged as a free-stamped tongue on the retaining means 11 and rests on the actuator 5 in the locked state of the locking device 1, and thus pretensions the retaining means 11, so that the retaining means 11 can independently spring out of its position after being detached from the fastening means 6.

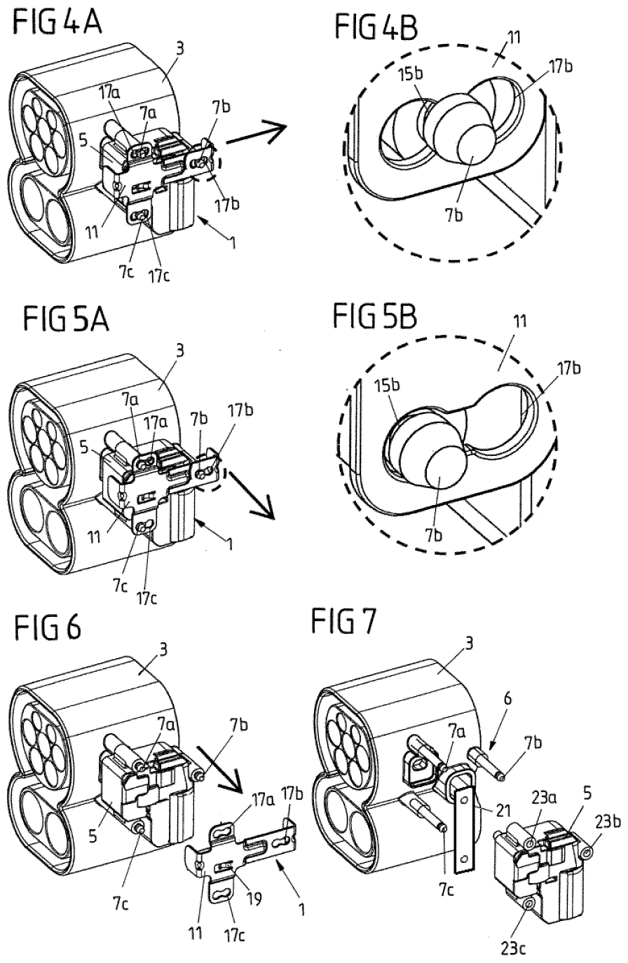

FIG. 4A—7 show different views of the charging socket 3 with the locking device 4 according to the first embodiment, previously shown in FIGS. 1 through 3, during an emergency unlocking process.

FIG. 4A shows a perspectival view of the charging socket 3 with the locking device 1 in a locked state. In the embodiment shown, for an emergency unlocking, the retaining means 11 is moved in the direction of the arrow shown. FIG. 4B shows an enlarged view of the region bordered by a dashed line in FIG. 4A. In the assembled state, in the embodiment shown, the tapered region between the two ends of the elongated hole of the second retaining geometry 17b is arranged in the respective first retaining geometry 15b, shown as a circumferential groove, on the respective fastening bolt 7b and thereby holds the actuator on the charging socket 3.

FIG. 5A shows a perspectival view of the charging socket 3 with the locking device 1 in an unlocked state. For this purpose, the retaining means 11 was moved in the direction of the arrow shown in FIG. 4A and is now detachable in the direction of the arrow shown in FIG. 5A. FIG. 5B shows an enlarged view of the region bordered by a dashed line in FIG. 5A. In the unlocked state, in the embodiment shown, one end of the elongated hole is located above the respective fastening bolt 7b, so that the retaining means 11 is detachable.

FIG. 6 shows a perspectival view of the charging socket 3 with the retaining means 11 removed. For example, the retaining means 11 can independently spring along the arrow direction shown from its position to the fastening bolts 7a-7c, due to the pretensioning by the spring element 19.

FIG. 7 shows a perspectival view of the charging socket 3 with the actuator 5 removed. For this purpose, the openings 23a-23c shown in FIG. 7 in the housing of the actuator 5 can be pushed out of the fastening bolts 7a-7c. Furthermore, FIG. 7 shows a compressible seal 21 that, in embodiments, can be arranged between the charging socket 3 and the actuator 5 and, in the assembled state, can pretension the retaining means 11 and the actuator 5. However, the seal 21 is not essential for moving the retaining means 11 and the actuator 5 from the locked state, and can only optionally be used in embodiments of the invention.

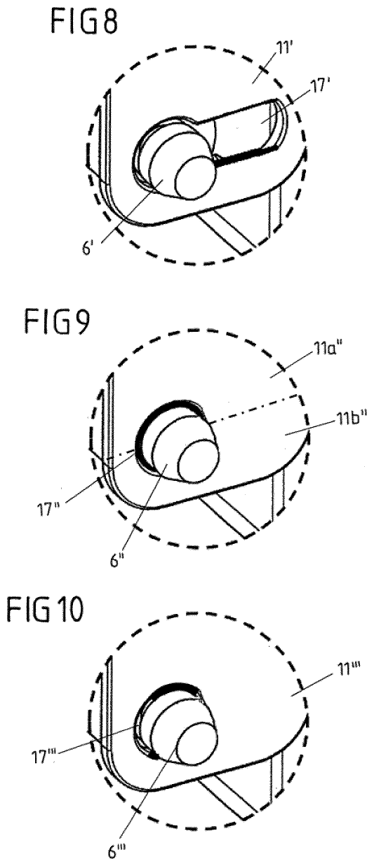

FIGS. 8 through 10 show views of retaining means 11′, 11a″, 11b″, 11′″ and fastening means 6′-6′″ according to a second, third, and fourth embodiment. The illustrations shown in FIGS. 8 through 10 each show cutouts of the respective detachable arrangements of retaining means 11′, 11a″, 11b“, 11′ and fastening means 6′-6′”.

FIG. 8 shows an arrangement similar to the arrangement shown in FIG. 4B, wherein, in contrast to the arrangement shown in FIG. 4B, the second retaining geometry 17′ has a keyhole contour. Thus, in the arrangement shown in FIG. 4B, the retaining means 11′ can be detached only in the position shown from the fastening bolt of the fastening means 6′.

In FIG. 9, the retaining means 11a″, 11b″ is designed in two parts and is arranged around the fastening means 6″. To detach the retaining means 11a″, 11b″ from the fastening means 6″, the two parts of the retaining means 11a″, 11b″ can be separated from one another. In the embodiment shown, the second retaining geometry 17″ is shown as a circular opening.

In the embodiment shown in FIG. 10, the second retaining geometry 17′ has connecting bars for a rotary closure—for example, a bayonet closure. In the embodiment shown, the retaining means 11′ is detachable from the fastening bolt of the fastening means 6′″ by means of a rotational movement.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Locking device
3 Charging socket
5 Actuator
6, 6′-6′″ Fastening means
7a-7c Fastening bolts
9 Locking pin
11, 11′, 11a″, 11b″, 11′″ Retaining means
13 Position securing means
15a-15c First retaining geometry
17a-17c, 17′-17′″ Second retaining geometry
19 Spring element
21 Seal
23a-23c Opening

1. A locking device for a charging socket for charging an electric vehicle, comprising:
an actuator configured to lock the charging socket with a corresponding charging plug in a plugged-on state;
a fastener which is fixable or fixed to the charging socket; and
a retainer configured to detachably arrange the actuator on the fastener,
wherein the retainer is arrangeable or arranged on the fastener and is detachable from the fastener via a relative movement between the retaining retainer and the fastener.

2. The locking device of claim 1, wherein the fastener comprises at least one fastening bolt,
wherein the fastening bolt is fixable or fixed at a first end to the charging socket and, at a second end that is opposite the first end, has a first retaining geometry configured to arrange the retainer.

3. The locking device of claim 2, wherein the first retaining geometry comprises a groove, arranged at least in regions on a circumference of the fastening bolt, or a collar.

4. The locking device of claim 2, wherein the actuator comprises a housing with at least one opening comprising a through-opening configured to receive the fastening bolt, at least in regions.

5. The locking device of claim 1, wherein the retainer is detachable from the fastener via a rotary closure comprising a bayonet closure or a sliding closure.

6. The locking device of claim 1, wherein the retainer comprises a fastening plate with at least one opening with a second retaining geometry configured to arrange the retainer on the fastener.

7. The locking device of claim 6, wherein the second retaining geometry comprises a keyhole contour, an elongated hole opened on one side, and/or a connecting bar section.

8. The locking device of claim 6, wherein the retainer comprises at least two parts.

9. The locking device of claim 6, wherein the retainer has a position securing means comprising a spring-loaded tab configured to retain the retainer on the actuator and/or the charging socket.

10. The locking device of claim 1, further comprising:
an elastic element comprising a spring element and/or a seal arranged on the retainer and/or between the actuator and the retainer.

11. A charging connection for an electric vehicle, comprising:
a charging socket; and
the locking device of claim 1,
wherein the locking device is arranged on the charging socket.
